(19) United States
(12) Patent Application Publication
(10) Pub. No.: US 2008/0280171 A1
(43) Pub. Date: Nov. 13, 2008

(54) Hydrogen Generation Device, Operation Method Thereof, and Fuel Cell System

(76) Inventors: Akira Maenishi, Osaka (JP); Tomonori Asou, Nara (JP); Yuji Mukai, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/884,303

(22) PCT Filed: Feb. 14, 2006
(86) PCT No.: PCT/JP2006/002536

§ 371 Date: Dec. 11, 2007

(30) Foreign Application Priority Data
Feb. 16, 2005 (JP) 2005-038932

(51) Int. Cl. H01M 8/18

(52) U.S. Cl. 429/17; 429/19

(57) ABSTRACT

A hydrogen generation device of the present includes: a reforming unit for steam-reforming raw material containing at least carbon atoms and hydrogen atoms to generate a hydrogen-containing gas; a raw material supply unit for supplying a raw material to the reforming unit; a steam generation unit for supplying steam to the reforming unit, a steam generation unit temperature detection unit for detecting the temperature of the steam generation unit; a heating unit for supplying a combustion gas for successively heating the reforming unit and the steam generation unit by heat transfer, and a control unit. The control unit controls a raw material supply amount from the raw material supply unit and a water supply amount from a water supply unit and controls one of the amount of the air to the heating unit, the amount of a fuel to the heating unit, and the amount of the raw material to the reforming unit so that no water remains in the steam generation unit according to the detected temperature from the steam generation unit temperature detection unit. Thus, it is possible to operate the hydrogen generation device without leaving water in the steam generating unit and to provide a hydrogen generation device operation method having a high reliability and economy and a hydrogen generation device using the same as well as a fuel cell generation system using the hydrogen generation device.

### TECHNICAL FIELD

The present invention relates to a hydrogen generation device which produces a hydrogen-rich gas from hydrocarbon materials, such as a natural gas, LPG, gasoline, naphtha, kerosene, methanol and the like, as a principal raw material through a steam-reforming reaction, an operation method thereof and a fuel cell system, and particularly the present invention relates to a hydrogen generation device which produces a hydrogen gas to be supplied to hydrogen utilizing equipments such as a fuel cell and the like, an operation method thereof and a fuel cell system.

### BACKGROUND ART

In the hydrogen generation device, steam-reforming of a raw material containing organic compounds composed of at least carbon atoms and hydrogen atoms is performed in a reforming unit including a reforming catalyst layer. A hydrogen-rich gas (hereinafter, referred to as a hydrogen gas) is produced as a reformed gas by this reforming reaction. If water is directly supplied to the reforming catalyst layer during a reforming reaction, reforming characteristics may be deteriorated due to uneven evaporation of water or a catalyst may be subject to damage due to water evaporation on the catalyst. Therefore, water is supplied to the reforming catalyst layer in a state of steam.

For example, a system in which a water supply passage communicated with a reforming catalyst layer of a reforming unit has a rising structure and a steam generation unit is located at the bottom of a passage formed by this structure is described in Japanese Laid-Open Patent Publication No. 2003-252604. In such a structure, supplied water is vaporized in the steam generation unit and the resulting steam is supplied to the reforming catalyst layer and water not vaporized in the steam generation unit remains at this bottom.

The hydrogen generation device generates steam by installing a steam generation unit in the device and supplying water to the steam generation unit. If this steam generation unit does not have sufficient evaporation capacity and cannot vaporize 100% of the supplied water, only as much steam as water is vaporized is supplied to the reforming catalyst layer and a steam-carbon ratio S/C, which is important in a reforming reaction and a ratio of the number of moles of steam supplied to the number of moles of carbon atoms in a raw material supplied, deviates from a set value and becomes small. On the other hand, water which cannot be vaporized remains in a steam generation unit as liquid water. If liquid water remains in the steam generation unit, when the steam generation unit reaches the condition, under which capability of evaporating supplied water is adequately attained due to changes in operating conditions, remained liquid water is vaporized to supply steam more than the amount of water being supplied and therefore a steam-carbon ratio S/C becomes larger than a set value until the evaporation of remained liquid water is completed. A deviation from a set value of S/C may affect reforming reaction characteristics on a reforming catalyst temperature. Furthermore, in the case where S/C becomes too small, carbon deposit blocks a passage due to a disproportionation reaction of gas after the reforming reaction and a higher temperature of a raw material supplied, and further a change in dew point of a product gas sent from the hydrogen generation device is caused, and thus the deviation may affect a hydrogen generation device or a system using the hydrogen generation device.

In addition, when the hydrogen generation device is shut down in a state in which liquid water remains, under such a condition that an ambient temperature is lowered and becomes below 0° C., water may freeze and break of the steam generation unit may cause the hydrogen generation device not to operate. Further, when the hydrogen generation device is shut down in a state in which liquid water remains, even if water does not freeze during shutdown, it takes an extra time by the amount of remained water before water is evaporated in the next startup or there is a possibility that steam supply under an unexpected condition takes place due to the evaporation of remained liquid water and steam is condensed on a catalyst located downstream, temperature of which is not yet raised, to cause the degradation of catalyst due to wetting or blockage of a passage due to water. Moreover, when such an operation that the steam generation unit is excessively heated so that liquid water does not remain all the time is employed, an amount of a raw material or fuel required for generating hydrogen increases and therefore hydrogen generation efficiency is deteriorated and the hydrogen generation device becomes uneconomical.

The present invention has been made in order to solve these problems and it is an object of the present invention to provide a hydrogen generation device which can be operated in such a way that liquid water does not remain in a steam generation unit and is highly reliable and economical, an operation method of the hydrogen generation device and a fuel cell power generation system including the hydrogen generation device.

### DISCLOSURE OF INVENTION

In order to solve the above-mentioned problems, a hydrogen generation device of the present invention includes: a reforming unit for steam-reforming raw material containing organic compounds composed of at least carbon atoms and hydrogen atoms to generate a hydrogen-containing gas; a steam generation unit for supplying steam to the reforming unit; a steam generation unit temperature detection unit for detecting the temperature of the steam generation unit; a heating unit for supplying a combustion gas for successively heating the reforming unit and the steam generation unit by heat transfer, and a control unit, wherein the control unit controls any one of an amount of the air to the heating unit, an amount of the fuel to the heating unit, and an amount of the water to the steam generation unit in such a way that a detected temperature of the temperature detection unit for a steam generation unit increases when the detected temperature is lower than a predetermined first threshold temperature.

In the hydrogen generation device of the present invention, it is also possible that the heating unit is constructed of a combustion unit which burns a mixture of fuel and air to produce a combustion gas, a fuel supply unit for supplying fuel to the combustion unit and a first air supply unit for supplying air to the combustion unit, and the control unit controls the first air supply unit in such a way that an amount of the air to the combustion unit increases when the detected temperature is lower than the first threshold temperature. Here, the control unit can increase the amount of the air to the heating unit so that an air ratio which is specified by a ratio of an actually supplied amount of the air to a theoretical amount of the air for burning the fuel completely is increased. For example, the control unit can increase the amount of the air to the heating unit in such a way that the air ratio is 1.5 or more. Further, it is also possible that a second air supply unit for supplying air to the combustion gas is installed in the heating unit, and the control unit controls the second air supply unit in such a way that an amount of the air increases when a detected temperature of the temperature detection unit for a steam generation unit is lower than a predetermined first threshold temperature.

In the hydrogen generation device of the present invention, it is also possible that the heating unit is constructed of a combustion unit which burns a mixture of fuel and air to produce a combustion gas, a fuel supply unit for supplying fuel to the combustion unit and a first air supply unit for supplying air to the combustion unit, and the control unit controls the fuel supply unit in such a way that an amount of the fuel to the combustion unit increases when the detected temperature is lower than the first threshold temperature.

In addition, in the hydrogen generation device of the present invention, it is also possible that a raw material supply unit for supplying a raw material and a water supply unit for supplying water to the steam generation unit are installed, and the control unit controls the raw material supply unit in such a way that an amount of the raw material to the reforming unit decreases and controls the water supply unit in such a way that an amount of the water to the steam generation unit decreases while the control unit maintains a steam-carbon ratio S/C, which is a ratio of the number of moles of steam supplied to the reforming unit to the number of moles of carbon atoms in a raw material supplied to the reforming unit, of a prescribed value when the detected temperature is lower than the first threshold temperature.

In addition, in the hydrogen generation device of the present invention, the control unit can also lower a temperature of the steam generation unit by controlling any one of supplied amounts and maintain the temperature of the steam generation unit between the first threshold temperature and the second threshold temperature when the detected temperature exceeds the second threshold temperature higher than the first threshold temperature. Here, the control unit can control the first air supply unit in such a way that an amount of the air to the combustion unit decreases when the detected temperature exceeds the second threshold temperature. In addition, the control unit can also reduce an amount of the fuel to the combustion unit by control of the fuel supply unit when the detected temperature exceeds the second threshold temperature. In addition, when the detected temperature is lower than the second threshold temperature, the control unit can control the raw material supply unit in such a way that an amount of the raw material to the reforming unit increases and control the water supply unit in such a way that an amount of the water to the steam generation unit increases while maintaining a steam-carbon ratio S/C of a prescribed value.

In addition, in the hydrogen generation device of the present invention, the control unit can also control any one of supplied amounts in such a way that a change per unit time in the detected temperature increases when a change per unit time in the detected temperature, which is derived from a first detected temperature detected by the temperature detection unit for a steam generation unit and a second detected temperature after a lapse of prescribed time, is lower than a first threshold value previously established with respect to change per unit time in the detected temperature.

Here, it is possible that the heating unit is constructed of a combustion unit which burns a mixture of fuel and air to generate a combustion gas, a fuel supply unit for supplying fuel to the combustion unit and a first air supply unit for supplying air to the combustion unit, and the control unit increases an amount of the air to the combustion unit by control of the first air supply unit when a change per unit time in the detected temperature is lower than the first threshold value.

In addition, it is also possible that the heating unit is constructed of a combustion unit which burns a mixture of fuel and air to produce a combustion gas, a fuel supply unit for supplying fuel to the combustion unit and a first air supply unit for supplying air to the combustion unit, and the control unit controls the fuel supply unit in such a way that an amount of the fuel to the heating unit increases when a change per unit time in the detected temperature is lower than the first threshold value.

In addition, in the hydrogen generation device of the present invention, it is also possible that a raw material supply unit for supplying a raw material and a water supply unit for supplying water to the steam generation unit are installed, and the control unit controls the raw material supply unit in such a way that an amount of the raw material to the reforming unit decreases and controls the water supply unit in such a way that an amount of the water to the steam generation unit decreases while maintaining a steam-carbon ratio S/C, which is a ratio of the number of moles of steam supplied to the reforming unit to the number of moles of carbon atoms in a raw material supplied to the reforming unit, at a prescribed value when a change per unit time in the detected temperature is lower than the first threshold value.

In addition, the control unit can also lower a change per unit time in the detected temperature by controlling any one of supplied amounts and maintain the change per unit time in the detected temperature of the steam generation unit between the first threshold temperature and the second threshold temperature when the change per unit time in the detected temperature exceeds the second threshold value higher than the first threshold value.

As the hydrogen generation device of the present invention, a system, in which the reforming unit and the steam generation unit are concentrically located in this order toward the periphery around the combustion unit and a combustion gas passage which is a passage of a combustion gas is placed so that a heat can be transferred from the reforming unit to the steam generation unit, can also be employed.

A fuel cell system of the present invention has at least the hydrogen generation device according to any one of claims 1 to 17 and a fuel cell which generates electric power using a hydrogen-containing gas supplied from the hydrogen generation device and an oxygen-containing gas.

An operation method of the hydrogen generation device of the present invention is an operation method of a hydrogen generation device having a reforming unit generating a hydrogen-containing gas by steam-reforming of a raw material containing organic compounds composed of at least carbon atoms and hydrogen atoms, a raw material supply unit for supplying a raw material to the reforming unit, a steam generation unit for supplying steam to the reforming unit, a steam generation unit temperature detection unit for detecting the temperature of the steam generation unit and a heating unit for burning a mixture of fuel and air and supplying a combustion gas for successively heating the reforming unit and the steam generation unit by heat transfer, wherein any one of an amount of the air to the foregoing heating unit, an amount of the fuel to the foregoing heating unit, and an amount of a water to the foregoing steam generation unit is controlled in such a way that a detected temperature of the foregoing steam generation unit temperature detection unit increases when the foregoing detected temperature is lower than a predetermined first threshold temperature.

In the operation method of the present invention, when the detected temperature is lower than the first threshold temperature, it is also possible to increase an amount of the air to the heating unit.

In addition, in the operation method of the present invention, when the detected temperature exceeds the second threshold temperature higher than the first threshold temperature, it is also possible to lower a temperature of the steam generation unit by controlling the foregoing any one of supplied amounts and to maintain the temperature of the steam generation unit between the first threshold temperature and the second threshold temperature.

In addition, in the operation method of the present invention, when the detected temperature exceeds the second threshold temperature, it is also possible to maintain the temperature of the steam generation unit between the first threshold temperature and the second threshold temperature by reducing an amount of the air to the heating unit.

In addition, in the operation method of the present invention, when a change per unit time in the detected temperature, which is derived from a first detected temperature detected by the temperature detection unit for a steam generation unit and a second detected temperature after a lapse of prescribed time, is lower than a first threshold value previously established with respect to change per unit time in the detected temperature, it is also possible to control any one of supplied amounts in such a way that a change per unit time in the detected temperature increases. Here, when the change per unit time in the detected temperature is lower than the second threshold value higher than the first threshold value, it is also possible to lower a change per unit time in the detected temperature by controlling any one of supplied amounts and maintain the change per unit time in the detected temperature between the first threshold value and the second threshold value.

According to the present invention, by controlling a quantity of heat transferred to the steam generation unit depending on a temperature condition of the steam generation unit, a water pool in the steam generation unit during operation can be prevented and all of water supplied can be converted to steam and supplied to a reaction unit. Thereby, the system can be operated under prescribed S/C conditions and stable reforming reaction characteristics and prevention of carbon deposition in a passage can be realized. In addition, since water does not exist in the steam generation unit when an operation is stopped, not only cryoprotective countermeasures become unnecessary, but also a starting time and starting characteristics at the next startup can be stabilized. Further, the present invention enables the above-mentioned effects with a small amount of a raw material and a fuel supply as far as possible. Therefore, a highly reliable and economical hydrogen generation device can be realized.

### BRIEF DESCRIPTION OF DRAWINGS

FIG. 1 is a schematic sectional view showing one example of a constitution of a reforming unit of a hydrogen generation device according to Embodiment 1 of the present invention;

FIG. 2 is a graph showing a relationship between an air ratio in the reforming unit of FIG. 1 and a temperature of the steam generation unit;

FIG. 3 is a graph showing a relationship between an air ratio in the reforming unit of FIG. 1 and a heat transfer quantity to a reforming catalyst layer and a heat transfer quantity to the steam generation unit;

FIG. 4 is an example of a flow chart of operational actions of the hydrogen generation device according to Embodiment 1;

FIG. 5 is a graph showing a relationship between air ratio and hydrogen generation efficiency in the reforming unit of FIG. 1;

FIG. 6 is an example of a flow chart of operational actions of the hydrogen generation device according to Embodiment 1;

FIG. 7 is a graph showing a relationship between a combustion quantity in the reforming unit of FIG. 1 and a temperature of the steam generation unit;

FIG. 8 is a graph showing a relationship between a raw material flow rate in the reforming unit of FIG. 1 and a temperature of the steam generation unit;

FIG. 9 is a schematic sectional view showing one example of a constitution of a reforming unit of a hydrogen generation device according to Embodiment 5 of the present invention;

FIG. 10 is a graph showing a relationship between an amount of the air from a second air supply unit shown in FIG. 9 and a temperature of the steam generation unit; and

FIG. 11 is a block diagram showing one example of a constitution of a fuel cell power generation system according to Embodiment 6 of the present invention.

### BEST MODE FOR CARRYING OUT THE INVENTION

Hereinafter, the embodiment of the present invention will be described in conjunction with drawings.

### EMBODIMENT 1

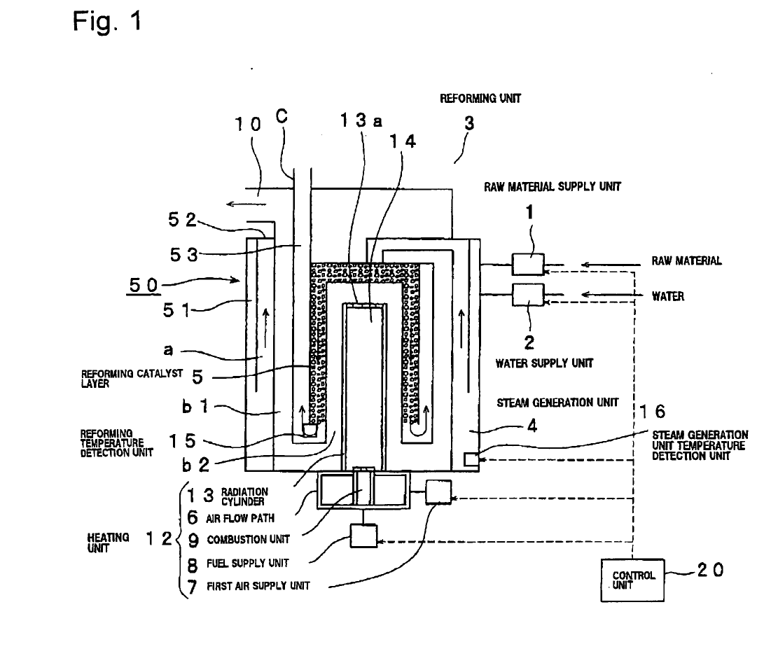

FIG. 1 is a schematic sectional view showing a constitution of a hydrogen generation device according to Embodiment 1 of the present invention and it particularly shows in detail a constitution of a reforming unit which is a principal constituent of the hydrogen generation device. As shown in FIG. 1, the hydrogen generation device includes a reforming unit 3 producing a hydrogen-containing gas by steam reforming of a raw material containing organic compounds composed of at least carbon atoms and hydrogen atoms and composed of a cylindrical main body 50 of which a top end and a bottom end are closed, a steam generation unit 4 supplying steam to the reforming unit 3, a steam generation unit temperature detection unit 16 (hereinafter, referred to as a temperature detection unit), which detects a temperature of the steam generation unit 4, a heating unit 12 which burns a mixture of fuel and air and supplies a combustion gas for successively heating the reforming unit 3 and the steam generation unit 4 by heat transfer and a control unit 20.

In the reforming unit 3, a plurality of vertical cylindrical walls 51 having different radiuses and axial lengths are concentrically placed inside the cylindrical main body 50 and thereby the inside of the main body 50 is divided radially. A lateral wall 52 in disc form or in hollow disc form is appropriately placed at a predetermined end of this vertical wall 51. Specifically, by concentrically placing a plurality of vertical walls 51 perpendicularly inside the main body 50, a clearance 53 is formed between the vertical walls 51, and a predetermined end of the vertical wall 51 is appropriately closed by the lateral wall 52 so as to form a desired gas passage using this clearance 53. Thereby, a passage a of a reforming raw material, a combustion gas passage b1, a reformed gas passage c, a reforming catalyst layer 5 and a combustion gas passage b2 are formed inside the main body 50 and these passages are located in this order toward the center from the peripheral side in the direction of radius of the main body.

An upstream end of the passage a of a reforming raw material is connected to a raw material supply unit 1 and a water supply unit 2, which are located outside the main body 50, and a downstream end of the passage a is connected to a top end face of the reforming catalyst layer 5. The passage a of a reforming raw material has a double cylindrical structure and takes on a rising structure which is structurally designed in such a way that the moving direction of a material moving through the passage is shifted from axially downward to axially upward. In addition, the steam generation unit 4 is located at the bottom of the passage a of a reforming raw material. As described later, water having supplied from the water supply unit 2 to the reforming unit 3 is vaporized by being supplied to this steam generation unit 4. A temperature detection unit 16 which detects a temperature of the steam generation unit 4 is located in this steam generation unit 4 and the temperature detection unit 16 is equipped with a thermocouple as a measure for sensing temperature. The location of the temperature detection unit 16 is not particularly limited as long as it is a position in the vicinity of a lower portion of the steam generation unit 4 where first and foremost, water is stored when water begins remaining without being vaporized, where a temperature of the steam generation unit 4 can be detected. Herein, a constitution of directly sensing a structural body wall constituting the steam generation unit 4 is used, but a constitution, in which the temperature detection unit 16 is installed within the steam generation unit 4 and directly senses a temperature of gas or steam flows inside the steam generation unit 4 or a temperature of water beginning remaining without being vaporized, may be used. In addition, as a location, a detection method and an object medium of detection of the temperature detection unit, any one may be used if it can be detected that water begins to remain without being vaporized in the steam generation unit 4. The temperature of the steam generation unit 4 detected by the temperature detection unit 16 is transmitted to a control unit 20. A constitution and a function of the control unit 20 will be described later, and the control unit 20 outputs signals to an air supply unit 7, a fuel supply unit 8, the raw material supply unit 1 and the water supply unit 2 based on this detected temperature and controls the amount of supplied streams. Here, the air supply unit 7 supplies air to the heating unit 12, the fuel supply unit 8 supplies fuel to the heating unit 12, and the raw material supply unit 1 supplies a raw material to the reforming unit 3.

The reforming catalyst layer 5 is formed by charging a reforming catalyst into the clearance 53 and it is placed along a top end face and a peripheral surface of a radiation cylinder 13 of the heating unit 12 described later. A reforming catalyst based on ruthenium (Ru) is used in this embodiment, but it is not particularly limited as long as a reforming reaction can be performed. For example, a reforming catalyst composed of a noble metal such as platinum (Pt) or rhodium (Rh) or nickel (Ni) may be used. The top end face of the reforming catalyst layer 5 is connected to the passage a of a reforming raw material and the bottom end face is connected to an upstream end of the reformed gas passage c. A downstream end of the reformed gas passage c is constructed in such a way the reforming gas can be drawn out of the reforming unit 3. A reforming temperature detection means 15 for sensing a temperature of gas which passes through the reforming catalyst layer 5 and flows through the reformed gas passage c is located within this reformed gas passage c, and a thermocouple is installed there as the reforming temperature detection means 15.

The heating unit 12 includes a combustion unit 9 consisting of, for example, a burner, an air passage 6 formed around the combustion unit 9 and a radiation cylinder 13 which is placed above the air passage 6 so as to surround a portion projecting upward from the air passage 6 of the combustion unit 9, and the radiation cylinder 13 is accommodated inside the main body 50 of the reforming unit 3 and are concentrically placed. The combustion unit 9 is connected to the fuel supply unit 8 and the air passage 6 is connected to the first air supply unit 7.

Air is supplied together with fuel for burning from the combustion unit 9 to the inside of the radiation cylinder 13 and fuel is burnt to form flames. A combustion space 14 is thus formed within the radiation cylinder 13. The combustion space 14 communicates with the combustion gas passage b2 of the reforming unit 3 through an opening 13a formed at the top end of the radiation cylinder 13. The combustion gas passage b2 communicates with the combustion gas passage b1 at the bottom of the reforming unit 3 and a downstream end of the combustion gas passage b1 is constructed in such a way the combustion gas can be drawn out of the reforming unit 3.

In addition, the raw material supply unit 1, the water supply unit 2, the first air supply unit 7 and the fuel supply unit 8, but figures are not shown, are constructed in such a way that flow rates of the respective objects supplied can be control led. For example, a constitution, in which these supply units 1, 2, 7 and 8 include driving means such as a pump, a fan and the like and these driving means are controlled by the control unit 20 to control the respective supply rates, may be employed, or a constitution, in which a flow rate control means such as a valve is further provided in the downstream passage of the driving means and this flow rate control means is controlled by the control unit 20 to control the respective supply rates, may be employed.

Next, actions during operation of the hydrogen generation device will be described.

In the heating unit 12, flames are formed from air supplied from the first air supply unit 7 and fuel supplied from the fuel supply unit 8. Here, an amount of the air and an amount of the fuel are controlled by the control unit 20 and generally air, which is 1.3 times more than a theoretical amount of the air for burning completely the fuel supplied to the heating unit 12, is supplied to the heating unit 12 to realize stable combustion. A high temperature combustion gas produced by this combustion passes through the radiation cylinder 13, and passes through the passage b2 between the radiation cylinder 13 and the reforming catalyst layer 5 and simultaneously exchanges heat with the reforming catalyst layer 5 to raise a temperature of the reforming catalyst layer 5 to a level at which a good reforming reaction can be performed. After exchanging heat with the reforming catalyst layer 5, the combustion gas exchanges heat with the steam generation unit 4 by passing through the passage b1 inside the steam generation unit 4 to provide the steam generation unit 4 with a heat quantity by which water can be evaporated and raise a temperature of the steam generation unit 4. In such a condition, steam is produced in the steam generation unit 4 by supplying water from the water supply unit 2, and the raw material supplied from the raw material supply unit 1 and the steam are mixed and sent to the reforming catalyst layer 5. Since a temperature of the reforming catalyst layer 5 has become sufficient for a reforming reaction, the reforming reaction takes place and a reformed gas containing hydrogen is sent forth out of the reforming unit 50 through a reformed gas passage c.

Thus, the reforming catalyst layer 5 and the steam generation unit 4 are together heated by the combustion gas from the heating unit 12 and the reforming catalyst layer 5 positioned upstream of a heat transfer path is heated prior to the steam generation unit 4 positioned downstream, and thereby the reforming catalyst layer 5 is brought into a high temperature of 600 to 700° C. at which a reforming reaction is well performed and the steam generation unit 4 is brought into a temperature of 100° C. or higher at which water can be evaporated while making effective use of the heat of the heating unit 12.

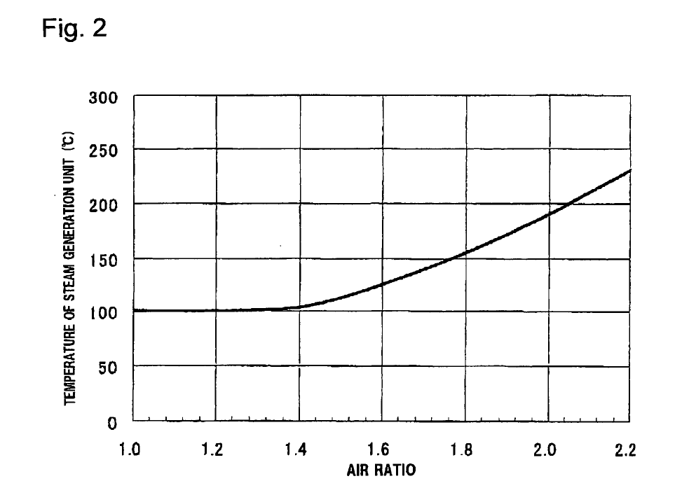

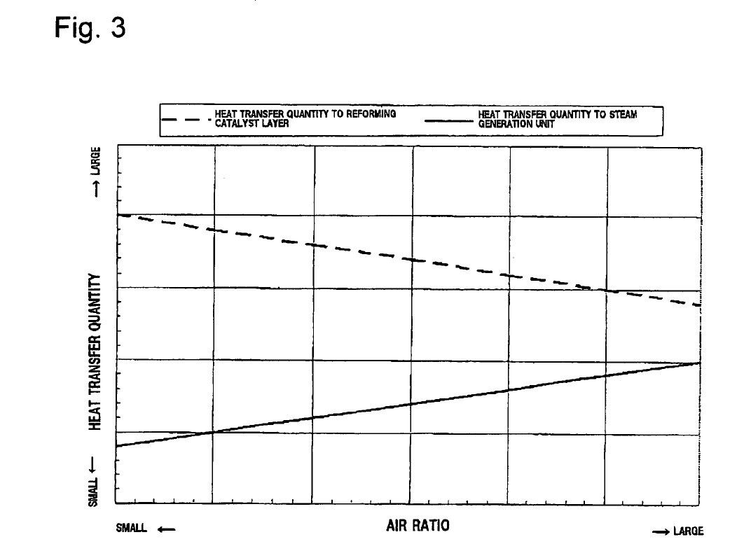

FIG. 2 is a graph showing a relationship between an air ratio in the heating unit 12 and a temperature of the steam generation unit 4 in operating a system under the condition of a constant amount of the raw material. In addition, FIG. 3 is a graph showing a relationship between an air ratio and a heat transfer quantity to a reforming catalyst layer 5 by a combustion gas and a heat transfer quantity to the steam generation unit 4.

When the air ratio is increased, a heat transfer quantity to the reforming catalyst layer 5 decreases since a flame temperature is lowered and a temperature of the combustion gas is lowered in the heating unit 12, and consequently a heat quantity contained in the combustion gas after exchanging heat with the reforming catalyst layer 5 is increased and therefore a heat transfer quantity to the steam generation unit 4 increases. Accordingly, when the air ratio becomes larger, the temperature of the steam generation unit becomes high. Incidentally, the reason why a temperature of the steam generation unit is substantially constant at about 100° C. when an air ratio is less than 1.4 is probably that if there is even any liquid water in the steam generation unit 4, the temperature of the steam generation unit will be about 100° C. regardless of an amount of liquid water stored in a bottom portion of the steam generation unit 4 since the latent heat of water is large. Further, a region where the temperature of the steam generation unit 4 with respect to the air ratio is 100° C. can vary depending on an ambient temperature, operating conditions and secular changes in operating conditions. FIG. 2 shows one example in operating the system under the condition under which water is most apt to pool among the above conditions.

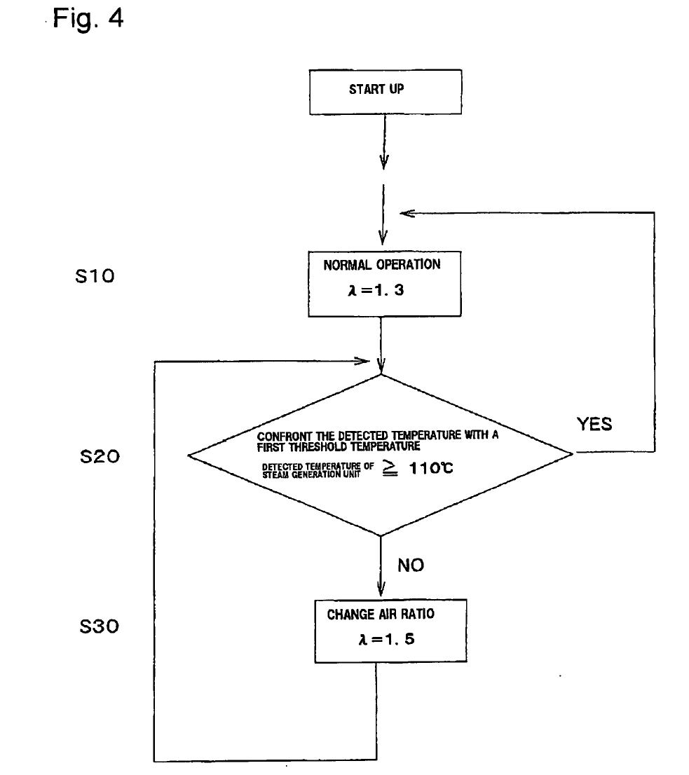

In FIG. 2, when the hydrogen generation device is operated at an air ratio of 1.3, liquid water begins to remain without being vaporized in the steam generation unit 4, for example in a bottom portion of the steam generation unit 4, since a temperature of the steam generation unit 4 is 100° C. And so, by controlling the system according to a flow chart shown in FIG. 4, a water pool in the steam generation unit 4 can be prevented. That is, in a condition in which an operation has progressed from startup through a warming up operation to a normal operation, the control of the hydrogen generation device proceeds to a step S10 in which the system is operated at an air ratio of 1.3. In addition, in the next step S20, the control unit 20 confronts the detected temperature of the steam generation unit 4, sent from the temperature detection unit 16, with a first threshold temperature, for example 110° C. Consequently, when the control unit 20 determines that the detected temperature is 110° C. or higher, the control unit 20 judges that all of water supplied to the steam generation unit 4 is vaporized and returns to the step S10, and there the control unit 20 controls the air supply unit 7 to operate at an air ratio of 1.3. On the other hand, when the control unit 20 determines that the temperature of the steam generation unit 4 is lower than 110° C., the control unit 20 judges that water begins to remain without being vaporized in the steam generation unit 4, proceeds to a step S30 and changes an air ratio to 1.5 by control of the air supply unit 7 to increase a heat transfer quantity to the steam generation unit 4 to accelerate the evaporation of water. And, the control of the hydrogen generation device returns to the step S20, the temperature of the steam generation unit 4 is measured by the temperature detection unit 16 and the step S20 and the subsequent steps are repeated.

By implementing such an operation, liquid water becomes hard to pool in the steam generation unit 4 by operating conditions, and even though liquid water begins to remain without being vaporized in the steam generation unit 4, for example in a bottom portion of the steam generation unit 4, an amount of water stored can be minimized. Thereby, it becomes possible to minimize the magnitude of and the duration of a deviation between steam-carbon ratios S/C (a ratio of the number of moles of steam supplied to the number of moles of carbon atoms in a raw material supplied) at the time when water begins to remain without being vaporized and at the time when stored water is evaporated.

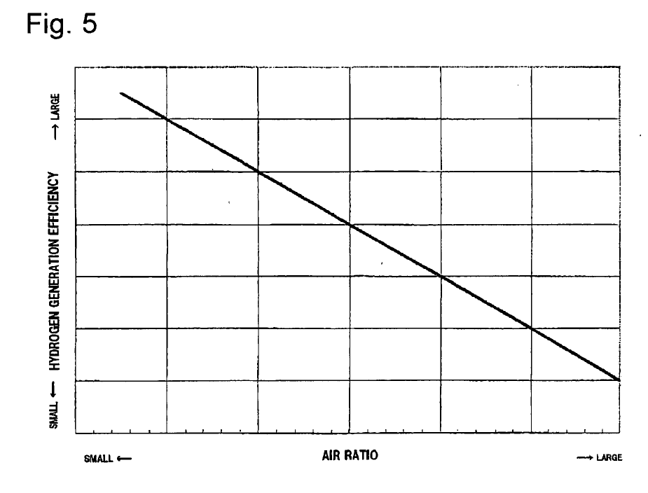

FIG. 5 is a view showing a relationship between air ratio and hydrogen generation efficiency. Here, the hydrogen generation efficiency is specified by a ratio of a heat quantity of hydrogen generated to a heat quantity of gas supplied. Higher hydrogen generation efficiency shows that hydrogen is generated making effective use of gas. As is evident from FIG. 5, when the air ratio is increased, a reforming efficiency tends to deteriorate. The reason for this is that the heat transfer quantity to the reforming catalyst layer 5 decreases and the heat transfer quantity to the steam generation unit 4 increases as the air ratio increases as shown in FIG. 3 and on the other hand, extra heat other than a heat quantity to be used for vaporization of water in the steam generation unit 4 is dissipated from the outermost steam generation unit 4 into the surroundings. That is, since a larger air ratio causes a larger heat quantity dissipated (heat loss) from the periphery of the system into the surroundings, the hydrogen generation efficiency is deteriorated. Therefore, if the air ratio is adjusted to be high all the time, the formation of the water pool in the steam generation unit 4 can be prevented in any operating condition but the hydrogen generation efficiency is deteriorated. However, in accordance with the operation method of this embodiment, the water pool can be prevented while maintaining the high hydrogen generation efficiency by operating at a higher air ratio than that in a normal operation only at a required timing.

Further, in actual control, if the operation is carried out using a threshold temperature of 110° C. alone, there is a possibility that the temperature of the steam generation unit 4, identified at the control unit 20, is changed to 111° C. or 109° C. momentarily due to an upset of temperature detection of the temperature detection unit 16 or fluctuations of signals in the control unit 20. In such a condition, a value of air ratio to be controlled continues to be changed to 1.3 or 1.5 momentarily and control of the combustion air supply unit 7 also continues to vary momentarily. Then, there is a possibility that this may causes the control of the combustion air supply unit 7 using a fan and the like, or other related equipment to be unstable.

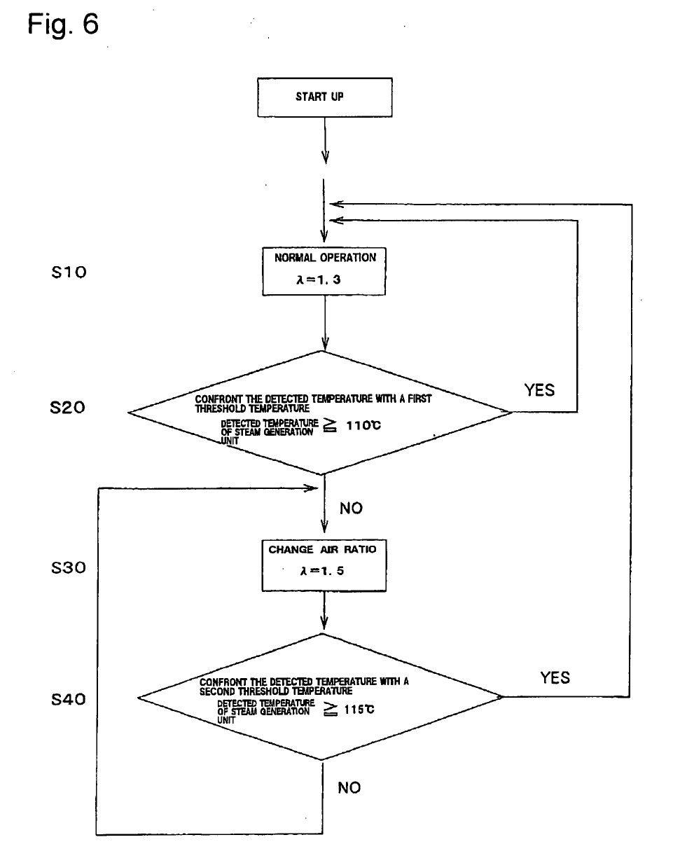

Consequently, stability of operating conditions may be secured by providing two threshold temperatures as shown in FIG. 6 and using selectively two threshold temperatures as the situation demands for the case where the temperature of the steam generation unit 4 increases and the case where the temperature of the steam generation unit 4 decreases. That is, in a condition in which an operation has progressed from startup through a warming up operation to a normal operation, the control of the hydrogen generation device proceeds to a step S10 in which the system is operated at an air ratio of 1.3. In the next step S20, the control unit 20 confronts the detected temperature sent from the temperature detection unit 16 with a first threshold temperature, for example 110° C. So, when the control unit 20 determines that the detected temperature is 110° C. or higher, the control unit 20 judges that all of water supplied to the steam generation unit 4 is vaporized and returns to the step S10, and there the control unit 20 controls the air supply unit 7 to operate at an air ratio of 1.3. On the other hand, when the control unit 20 determines that the temperature of the steam generation unit 4 is lower than 110° C., the control unit 20 judges that liquid water begins to remain without being vaporized in the steam generation unit 4, proceeds to a step S30 and changes an air ratio to 1.5 by control of the air supply unit 7. In the next step S40, the control unit 20 confronts the detected temperature sent from the temperature detection unit 16 with a second threshold temperature, for example 115° C. So, when the control unit 20 determines that the detected temperature is 115° C. or higher, the control unit 20 returns to the step S10 and controls the air supply unit 7 to operate at an air ratio of 1.3. On the other hand, when the control unit 20 determines that the detected temperature is lower than 115° C., the control unit 20 returns to the step S30 and continues the operation at an air ratio of 1.5 and repeats the step S30 and the subsequent steps.

If using such actions, the temperature of the steam generation unit 4 does not vary momentarily between 110° C. and 115° C. Therefore, it becomes possible to put a time interval between timings of controlling an air ratio and it is possible to prevent the momentary change from causing the instability of the control.

As another method, a method, in which an air ratio is set for a threshold temperature and after this set value of an air ratio is changed once, a time period, during which a newly set air ratio is retained, is provided to avoid the air ratio from changing for a given length of time, and thereby operational control is stabilized, may also be used.

In addition, in the above description, a temperature of 110° C. is used as a threshold temperature, but this is just one example and other temperatures can be employed depending on a constitution of the steam generation unit and a location of the temperature detection unit to be installed. In addition, as for an air ratio, a set value of 1.3 is used as an initial value and a set value of 1.5 is used at the time of accelerating evaporation of water, but these are just one example and other values suitable for the hydrogen generation device can be employed depending on characteristics of the reforming unit or the combustion unit.

Thus, in the hydrogen generation device of this embodiment, the control unit 20 confronts the detected temperature of the steam generation unit with the threshold temperature and increases an air ratio when it is judged that liquid water begins to remain without being vaporized in the steam generation unit and decreases an air ratio when it is judged that liquid water does not begin to remain without being vaporized, and thereby an amount of the air to the heating unit can be controlled, the formation of a water pool during operation can be prevented while minimizing reduction in the hydrogen generation efficiency to realize high reliability.

### EMBODIMENT 2

The hydrogen generation device of this embodiment has the same constitution as in Embodiment 1 except that the control unit has a function of judging whether liquid water begins to remain without being vaporized in the steam generation unit or not based on a threshold value derived from an change per unit time in the detected temperature in place of the threshold temperature.

For example, when the detected temperature of the steam generation unit 4 is 130° C., liquid water does not begin to remain without being vaporized even after a lapse of ten minutes if a change ΔTw per unit time of the detected temperature is −1.0 deg/min, but liquid water begins to remain without being vaporized after five minutes if a ΔTw is −2.0 deg/min. In addition, when the detected temperature is 120° C., liquid water does not begin to remain without being vaporized even after a lapse of ten minutes if a change ΔTw per unit time of the detected temperature is −0.5 deg/min, but liquid water begins to remain without being vaporized after five minutes if a ΔTw is −1.0 deg/min.

So, in the operation method of a hydrogen generation device of this embodiment, a threshold value of a change per unit time is established for each temperature of the steam generation unit 4 in such a way that a threshold value of −1.5 deg/min is used when the temperature of the steam generation unit 4 is 130° C. and a threshold value of −0.8 deg/min is used when the temperature is 120° C. For example, a situation in which a normal operation is carried out at an air ratio of 1.3 is assumed. The control unit 20 confronts an actual change per unit time in the detected temperature (first detected temperature) which is determined from the detected temperature sent from the temperature detection unit 16 with a first threshold value set for the first detected temperature, and when the control unit 20 determines that the actual change per unit time is lower than the first threshold value, it judges that liquid water begins to remain without being vaporized after a short time and changes an air ratio from an initial value of 1.3 to 1.5 by control of the air supply unit 7. On the other hand, when the control unit 20 determines that the actual change per unit time is higher than the threshold value, the control unit 20 judges that liquid water does not remain and maintains an air ratio of 1.3. In addition, the actual change per unit time is determined from the first detected temperature and a second detected temperature after a lapse of prescribed time and the change per unit time in this first detected temperature is confronted with the first threshold value set for the first detected temperature.

In accordance with the hydrogen generation device of this embodiment, it becomes possible to operate the system without pooling liquid water at all and in a state of being as low in an air ratio as possible by predicting previously that liquid water remains in the steam generation unit 4, and therefore a hydrogen generation device having high hydrogen generation efficiency and high reliability and an operation method of the hydrogen generation device can be realized.

On the occasion of the operation of the hydrogen generation device, if the operation is carried out setting one threshold value alone, there is a possibility that an air ratio continues to be changed momentarily when an actual change per unit time varies around this one threshold value. Thus, the system may be adapted to avoid the air ratio from continuing to be changed momentarily by establishing two threshold values also in this embodiment as with Embodiment 1 and following the same operating procedure as that shown in the flow chart of FIG. 6. That is, a second threshold value higher than the first threshold value is set in addition to the first threshold value for the first detected temperature and the air ratio is changed so that the actual change per unit time does not exceed the second threshold value.

Even when the operation is carried out using one threshold value alone, it is possible to prevent the air ratio from continuing to be changed momentarily by retaining a newly set air ratio for a predetermined length of time.

Further, it is possible to operate the system without pooling liquid water in the steam generation unit and in a state of being high in the hydrogen generation efficiency if control is performed with higher accuracy by keeping track of the detected temperature and the change per unit time in the detected temperature always and judging whether the temperature of the steam generation unit becomes below the first threshold temperature or not using any prediction method as distinct from judging by only the change per unit time in the first detected temperature at some point in time like the above method.

### EMBODIMENT 3

The hydrogen generation device of this embodiment has the same constitution as in Embodiment 1 except that the control unit has a function of controlling an amount of the fuel to the heating unit in place of a function of controlling an amount of the air to the heating unit in order to vaporize liquid water and not to increase the amount of the liquid water when the control unit judges that liquid water begins to remain without being vaporized in the steam generation unit.

A situation in which a normal operation is carried out at a predetermined fuel rate, for example 1.5 NLM, is assumed. When the detected temperature of the steam generation unit 4 is lower than a threshold temperature, for example 110° C., the control unit 20 increases an amount of the fuel supplied from the fuel supply unit 8. When a city gas 13A is supplied as fuel, the predetermined amount of the fuel of 1.5 NLM is increased by 0.2 NLM to 1.7 NLM. Conversely, when the detected temperature is higher than 110° C., the fuel rate is changed back to the predetermined amount of 1.5 NLM.

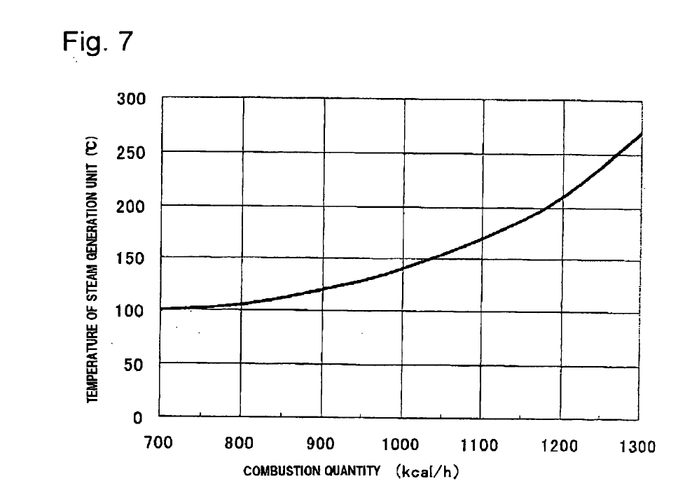

FIG. 7 is a view showing a relationship between a combustion rate and a temperature of the steam generation unit 4. As is evident from this drawing, when the combustion rate is increased, the temperature of the steam generation unit 4 increases since a heat transfer quantity to the steam generation unit 4 increases. Therefore, when liquid water begins to remain without being vaporized in the steam generation unit 4, a combustion rate is increased by increasing an amount of the fuel from the fuel supply unit 8 to accelerate the evaporation of water in the steam generation unit 4. On the other hand, when liquid water does not remain in the steam generation unit 4, the fuel rate is changed back to the prescribed rate to prevent an excessive heat supply. Thereby, a hydrogen generation device having high reliability and high hydrogen generation efficiency and an operation method of the hydrogen generation device can be realized.

In addition, as a criterion for judging whether liquid water begins to remain without being vaporized in the steam generation unit 4 or not, an actual change per unit time in the detected temperature may be employed as with Embodiment 2.

### EMBODIMENT 4

The hydrogen generation device of this embodiment has the same constitution as in Embodiment 1 except that the control unit has a function of controlling an amount of the raw material to the reforming unit in place of a function of controlling an amount of the air to the heating unit in order to increase an amount of the steam to the steam generation unit.

A situation in which a normal operation is carried out at a predetermined amount of the raw material, for example 4.0 NLM, is assumed. When the detected temperature of the steam generation unit 4 is lower than a threshold temperature, for example 110° C., the control unit 20 judges that liquid water begins to remain without being vaporized and decreases an amount of the raw material from the raw material supply unit 1. When a city gas 13A is used as a raw material, the predetermined amount of the raw material of 4.0 NLM is decreased by 0.5 NLM to 3.5 NLM. Conversely, when the detected temperature is higher than 110° C., the control unit 20 judges that liquid water does not remain and changes the amount of the raw material from the raw material supply unit 1 back to the predetermined rate of 4.0 NLM.

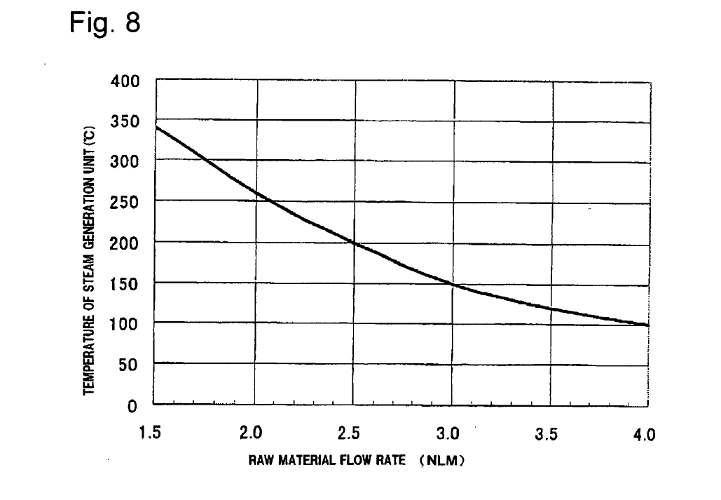

FIG. 8 is a view showing a relationship between a raw material flow rate (amount of the raw material) and a temperature of the steam generation unit 4 under the condition of a constant air ratio. As is evident from this drawing, when the amount of the raw material is decreased, the temperature of the steam generation unit 4 increases. The reason for this is that since the hydrogen generation device is generally operated at a constant S/C irrespective of an amount of the raw material, a required amount of the steam is also decreased when the amount of the raw material is reduced. Since an amount of the water supplied is also decreased when the amount of the steam is decreased, a heat quantity required for vaporization of water is decreased. Thus, when the amount of the raw material is reduced, the temperature of the steam generation unit 4 increases as shown in FIG. 8. Thereby, a highly reliable operation method can be realized.

In addition, as a criterion for judging whether liquid water begins to remain without being vaporized in the steam generation unit 4 or not, a method of confronting an actual change per unit time in the detected temperature with a threshold value thereof may be employed as with Embodiment 5.

### EMBODIMENT 5

The hydrogen generation device of this embodiment has the same constitution as in Embodiment 1 except for installing a second air supply unit for supplying air to a combustion gas.

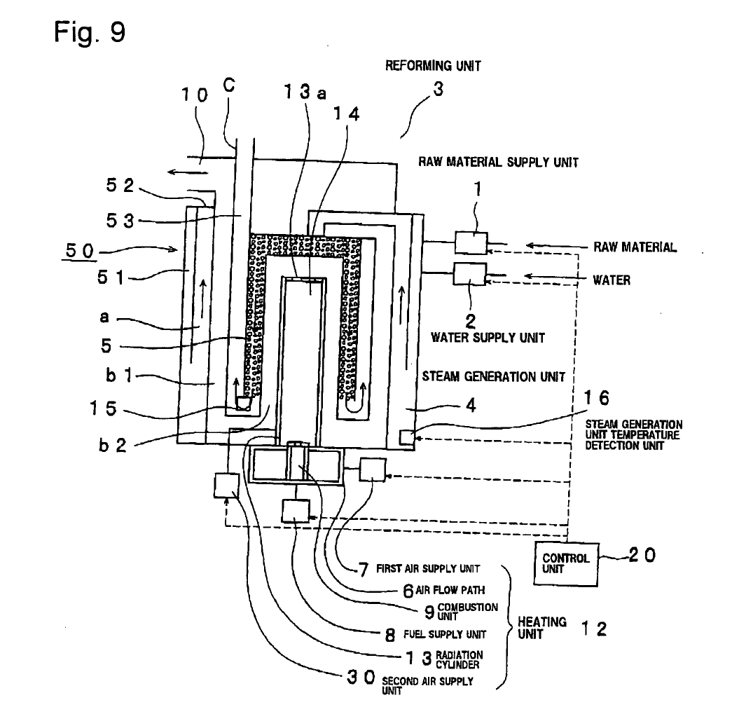

FIG. 9 is a schematic sectional view showing a constitution of a hydrogen generation device of this embodiment. The hydrogen generation device of this embodiment has the constitution in which air from the second air supply unit 30 can be supplied to a position of not disturbing a combustion condition in the heating unit 12 of the radiation cylinder 13. The second air supply unit 30 is constructed so as to control the air supply amount by signals from the control unit 20.

An operation method in the case where the control unit judges that liquid water begins to remain without being vaporized in the steam generation unit 4 in the above-mentioned constitution will be described. When the control unit 20 confronts the detected temperature sent from the temperature detection unit 16 with a threshold temperature, for example 110° C., determines that the detected temperature is lower than 110° C. and judges that liquid water begins to remain without being vaporized, the control unit 20 supplies air in an amount of 5NLM, for example, from the second air supply unit 30. On the other hand, when the control unit 20 judges that liquid water does not remain, it does not carry out the air supply from the second air supply unit 30.

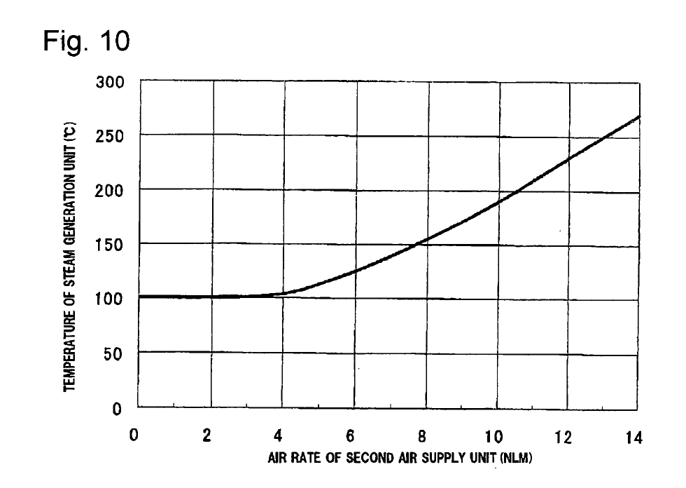

FIG. 10 is a view showing a relationship between an amount of the air from a second air supply unit and a temperature of the steam generation unit 4. When the amount of the air is increased, the temperature of the steam generation unit 4 increases. The reason for this is that by mixing air from the second air supply unit 30 in a high temperature combustion gas produced in the heating unit 12, a temperature of the combustion gas is lowered while maintaining the total heat quantity of the combustion gas to suppress a heat transfer quantity to the reforming catalyst layer 5, and thereby the total heat quantity of the combustion gas entering the steam generation unit 4 is increased to increase a heat transfer quantity to the steam generation unit 4.

In this embodiment, a heat transfer quantity to the steam generation unit 4 is controlled and the formation of a water pool in the steam generation unit 4 is inhibited without bringing about change in combustion reaction conditions in the combustion unit 9 in contrast to Embodiment 1 by mixing air in a combustion gas produced in the heating unit 12. Thereby, a hydrogen generation device having high reliability and high hydrogen generation efficiency can be realized.

In addition, as a location to which air is supplied from the second air supply unit, a position, which is on the combustion gas passage up to the steam generation unit and does not disturb a combustion condition when supplying air, may be employed and a position within the radiation cylinder 13 or on the combustion gas passage b2 through which the combustion gas passes after exiting the radiation cylinder 13 may be selected. However, when the location to which air is supplied is placed on the combustion gas passage b2, the position close to the steam generation unit 4 is not preferred. The reason for this is that when a supplying point is close to the steam generation unit 4, an effect of suppressing a heat transfer quantity to the reforming catalyst layer 5 after mixing air until reaching the steam generation unit 4 is reduced and consequently an effect of increasing a heat transfer quantity to the steam generation unit 4 is reduced.

In addition, as a criterion for judging whether liquid water begins to remain without being vaporized in the steam generation unit 4 or not, a method of confronting an actual change per unit time in the detected temperature with a threshold value thereof may be employed as with Embodiment 2.

### EMBODIMENT 6

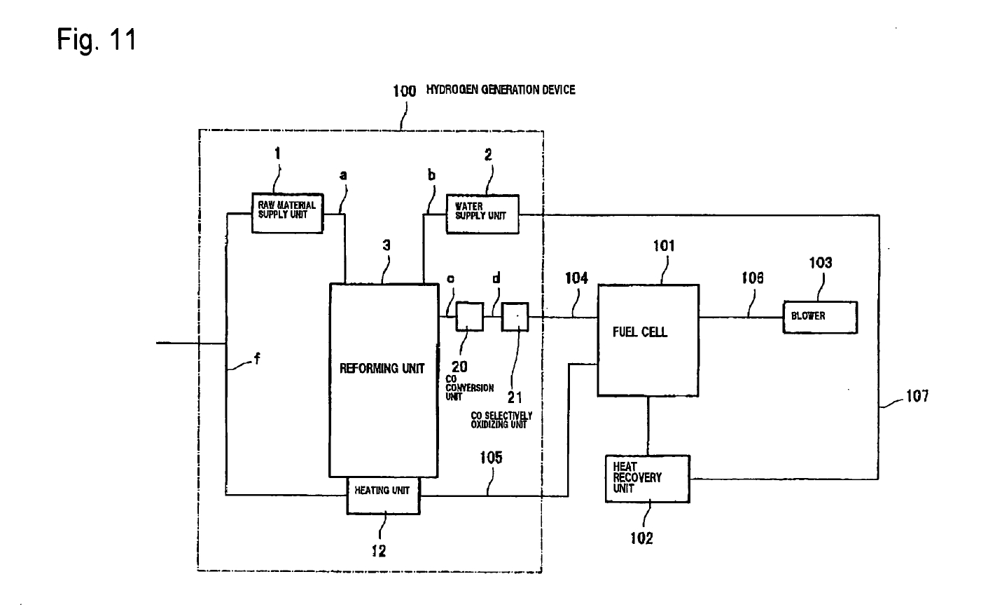

FIG. 11 is a block diagram showing schematically a constitution of a fuel cell power generation system of this embodiment. This fuel cell power generation system includes a hydrogen generation device 100, a fuel cell 101, a heat recovery device 102 and a blower 103 as a main constituent. This fuel cell 101 is, for example, a solid polymer electrolyte fuel cell.

For the hydrogen generation device 100, any one of hydrogen generation devices in Embodiments 1 to 5 can be used and this hydrogen generation device 100 further includes carbon monoxide (CO) conversion unit 20 and a carbon monoxide (CO) selectively oxidizing unit 21 in addition to the above-mentioned reforming unit 3 and heating unit 12. Specifically, the reformed gas passage c of the reforming unit 3 in FIG. 1 is connected to the CO conversion unit 20 and a converted gas passage d is connected between the CO conversion unit 20 and the CO selectively oxidizing unit 21. In the hydrogen generation device 100 of such a constitution, a reformed gas produced in the reforming catalyst layer 5 is supplied to the CO conversion unit 20 through the reformed gas passage c and a CO concentration is reduced there. A converted gas obtained in the CO conversion unit 20 is supplied to the CO selectively oxidizing unit 21 through the converted gas passage d and a CO concentration is further reduced there. By reducing the CO concentration by the CO conversion unit 20 and the CO selectively oxidizing unit 21 like this, a hydrogen-rich gas (hydrogen gas) having a low CO concentration is obtained in the hydrogen generation device 100.

In the fuel cell power generation system, the hydrogen generation device 100 is connected to a fuel cell 101 through a power generation fuel line 104 and a fuel off gas line 105. In addition, the fuel cell 101 is connected to a blower 103 through an air line 106. In addition, the heat recovery device 102 is constructed so as to recover heat generated during the fuel cell 101 generates electric power. In this embodiment, the heat recovery device 102 is composed of a hot water generating device including a hot water storage tank and heat generated during the fuel cell 101 generates electric power is recovered by water in this hot water storage tank to generate hot water. By the way, not shown in this embodiment, the fuel cell power generation system is constructed so as to supply electric power obtained by power generation to a power load terminal and it is constructed so as to supply heat recovered by the heat recovery device 102 to a heat load terminal.

A hydrogen gas produced in the hydrogen generation device 100 is supplied to a fuel electrode side of the fuel cell 101 through the power generation fuel line 104 as fuel for power generation. On the other hand, air is supplied from the blower 103 to an air electrode side of the fuel cell 101 through the air line 106. In the fuel cell 101, the supplied hydrogen gas reacts (hereinafter, referred to as a power generation reaction) with supplied air to generate electric power and heat is generated in association with this power generation reaction. Electric power obtained by the power generation reaction is supplied to a power load terminal (not shown) to be used. In addition, heat generated in association with a power generation reaction is recovered by a heat recovery means 102 and then supplied to a heat load terminal (not shown) to be used in various applications. In addition, an unused hydrogen gas (so-called off gas) which has not been used for the power generation reaction is recovered from the fuel cell 101 and supplied to the heating unit 12 of the hydrogen generation device 100 through the fuel off gas line 105 as fuel for burning.

The fuel cell power generation system of this embodiment can be operated in such a way that liquid water does not remain in the steam generation unit 4 of the hydrogen generation device 100 as described in Embodiments 1 to 5. Thus, it becomes possible to carry out highly reliable production of a hydrogen gas and supply stably a hydrogen gas to the fuel cell 101. Thus, in the fuel cell 101, it becomes possible to generate electric power energy and heat energy stably in efficiency and realize a cogeneration system which is superior in energy conservation and economy.

By the way, the hydrogen generation device used in this embodiment can be used for applications other than the fuel cell power generation system.

Further, in this fuel cell power generation system, reducing a power generation rate is associated with the reduction in a raw material rate. Accordingly, as an operation method of preventing a water pool in the steam generation unit, a method of reducing the power generation rate can also be employed. For example in the fuel cell power generation system running in a state of power generation of 1 kW, when the detected temperature of the steam generation unit 4 is lower than a threshold temperature, for example 110° C., and the control unit judges that water begins to remain without being vaporized, it is also possible to control so as to reduce a power generation rate to 900 W by sending signals from the control unit to a control unit of the system (not shown). On the other hand, when the detected temperature of the steam generation unit 4 is higher than 110° C. and the control unit judges that liquid water does not remain, the operation is performed changing the power generation rate back to 1 kW. Thereby, the water pool in the steam generation unit 4 can be prevented and a highly reliable fuel cell power generation system can be realized.

Further, in Embodiments 1 to 5, fuel is supplied by the fuel supply unit 8 but fuel can also be supplied using an off gas from the fuel cell of the fuel cell power generation system as with Embodiment 6.

The hydrogen generation device of the present invention is useful as a hydrogen generation device which can implement a highly reliable operation by which water does not remain in a steam generation unit during the operation. Particularly in a fuel cell system including this hydrogen generation device, it becomes possible to carry out stably cogeneration operation which is superior in economy and energy conservation.

1. A hydrogen generation device comprising:
a reforming unit for steam-reforming of a raw material containing organic compounds composed of at least carbon atoms and hydrogen atoms to generate a hydrogen-containing gas;
a steam generation unit for supplying steam to the reforming unit;
a steam generation unit temperature detection unit for detecting a temperature of the steam generation unit;
a heating unit which burns a mixture of fuel and air and supplies a combustion gas for successively heating the reforming unit and the steam generation unit by heat transfer; and
a control unit which controls any one of an amount of the air to the heating unit, and an amount of a water to the steam generation unit so that a detected temperature of the steam generation unit temperature detection unit increases when the detected temperature is lower than a predetermined first threshold temperature,
wherein said heating unit comprises a combustion unit which burns a mixture of fuel and air to produce a combustion gas, a fuel supply unit for supplying fuel to the combustion unit, a first air supply unit for supplying air to the combustion unit and a second air supply unit for supplying air to said combustion gas, and said control unit controls the second air supply unit in such a way that an amount of the air increases when a detected temperature of said temperature detection unit for a steam generation unit is lower than a predetermined first threshold temperature.

2. (canceled)

3. The hydrogen generation device according to claim 1,
wherein said control unit increases the amount of the air supplied to the heating unit in such a way that an air ratio which is specified by a ratio of an actually supplied air rate to a theoretical air rate for burning said fuel completely is increased.

4. The hydrogen generation device according to claim 3,
wherein said control unit increases the amount of the air supplied to the heating unit in such a way that said air ratio is 1.5 or more.

5. (canceled)

6. The hydrogen generation device according to claim 1,
wherein said heating unit comprises a combustion unit which burns a mixture of fuel and air to produce a combustion gas,
a fuel supply unit for supplying fuel to the combustion unit and
a first air supply unit for supplying air to the combustion unit, and
said control unit controls the fuel supply unit in such a way that a fuel rate supplied to said combustion unit increases when said detected temperature is lower than the first threshold temperature.

7. The hydrogen generation device according to claim 1,
comprising a raw material supply unit for supplying said raw material and a water supply unit for supplying water to said steam generation unit, wherein said control unit controls said raw material supply unit in such a way that an amount of a raw material supplied to said reforming unit decreases and controls said water supply unit in such a way that an amount of the water supplied to said steam generation unit decreases while maintaining a steam-carbon ratio S/C, which is a ratio of the number of moles of steam supplied to said reforming unit to the number of moles of carbon atoms in a raw material supplied to said reforming unit, at a prescribed value when said detected temperature is lower than the first threshold temperature.

8. The hydrogen generation device according to claim 1,
wherein said control unit lowers a temperature of said steam generation unit by controlling said any one of supplied amounts and maintains the temperature of the steam generation unit between said first threshold temperature and a second threshold temperature higher than said first threshold temperature when said detected temperature exceeds the second threshold temperature.

9. The hydrogen generation device according to claim 6,
wherein said control unit controls the first air supply unit in such a way that an amount of the air supplied to the combustion unit decreases when the detected temperature exceeds the second threshold temperature.

10. The hydrogen generation device according to claim 6,
wherein said control unit reduces an amount of the fuel supplied to the combustion unit by control of the fuel supply unit when the detected temperature exceeds the second threshold temperature.

11. The hydrogen generation device according to claim 6,
wherein said control unit controls the raw material supply unit in such a way that an amount of the raw material supplied to the reforming unit increases and controls the water supply unit in such a way that an amount of the water supplied to the steam generation unit increases while maintaining a steam-carbon ratio S/C at a prescribed value when the detected temperature is lower than the second threshold temperature.

12. The hydrogen generation device according to claim 1,
wherein said control unit controls the any one of supplied amounts in such a way that a change per unit time in the detected temperature increases when a change per unit time in the detected temperature, which is derived from a first detected temperature detected by the steam generation unit temperature detection unit and a second detected temperature after a lapse of prescribed time, is lower than a first threshold value previously established with respect to change per unit time in the detected temperature.

13. The hydrogen generation device according to claim 10,
wherein said heating unit has a combustion unit which burns a mixture of fuel and air to produce a combustion gas,
a fuel supply unit for supplying fuel to the combustion unit and
a first air supply unit for supplying air to the combustion unit, and
said control unit increases an amount of the air supplied to the combustion unit by control of the first air supply unit when a change per unit time in the detected temperature is lower than the first threshold value.

14. The hydrogen generation device according to claim 10,
wherein said heating unit has a combustion unit which burns a mixture of fuel and air to produce a combustion gas,
a fuel supply unit for supplying fuel to the combustion unit and
a first air supply unit for supplying air to the combustion unit, and
said control unit controls the fuel supply unit in such a way that an amount of the fuel supplied to the heating unit increases when a change per unit time in the detected temperature is lower than the first threshold value.

15. The hydrogen generation device according to claim 10, comprising
a raw material supply unit for supplying the raw material and
a water supply unit for supplying water to the steam generation unit, and
said control unit controls the raw material supply unit in such a way that an amount of the raw material supplied to the reforming unit decreases and controls the water supply unit in such a way that an amount of the water supplied to the steam generation unit decreases while maintaining a steam-carbon ratio S/C, which is a ratio of the number of moles of steam supplied to the reforming unit to the number of moles of carbon atoms in a raw material supplied to the reforming unit, at a prescribed value when a change per unit time in the detected temperature is lower than the first threshold value.

16. The hydrogen generation device according to claim 10,
wherein said control unit lowers a change per unit time in the detected temperature by controlling the any one of supplied amounts and maintains the change per unit time in the detected temperature of the steam generation unit between the first threshold temperature and the second threshold temperature when the change per unit time in the detected temperature exceeds the second threshold value higher than the first threshold value.

17. The hydrogen generation device according to claim 1,
wherein said reforming unit and said steam generation unit are concentrically located in this order toward the periphery around the combustion unit and a combustion gas passage which is a passage of the combustion gas is placed so that a heat is transferred from the reforming unit to the steam generation unit.

18. A fuel cell system having at least the hydrogen generation device according to claim 1 and a fuel cell which generates electric power using a hydrogen-containing gas supplied from the hydrogen generation device and an oxygen-containing gas.

19. An operation method of a hydrogen generation device having a reforming unit generating a hydrogen-containing gas by steam-reforming of a raw material containing organic compounds composed of at least carbon atoms and hydrogen atoms, a raw material supply unit for supplying a raw material to the reforming unit, a steam generation unit for supplying steam to the reforming unit, a steam generation unit temperature detection unit for detecting a temperature of the steam generation unit and a heating unit which burns a mixture of fuel and air and supplies a combustion gas for successively heating the reforming unit and the steam generation unit by heat transfer,
wherein any one of a rate supplied of an amount of the air to the heating unit, an amount of the fuel to the heating unit, and an amount of the water to the steam generation unit is controlled in such a way that a detected temperature of the temperature detection unit for a steam generation unit increases when the detected temperature is lower than a predetermined first threshold temperature, and wherein said any one of supplied amounts is controlled in such a way that a change per unit time in the detected temperature increases when a change per unit time in the detected temperature, which is derived from a first detected temperature detected by the temperature detection unit from a steam generation unit and a second detected temperature after a lapse of prescribed time, is lower than a first threshold value previously established with respect to change per unit time in the detected temperature.

20. The operation method of a hydrogen generation device according to claim 17,
wherein an amount of the air supplied to the heating unit is increased when the detected temperature is lower than the first threshold temperature.

21. The operation method of a hydrogen generation device according to claim 17,
wherein a temperature of the steam generation unit is lowered by controlling the any one of supplied amounts and the temperature of the steam generation unit is maintained between the first threshold temperature and the second threshold temperature when the detected temperature exceeds the second threshold temperature higher than the first threshold temperature.

22. The operation method of a hydrogen generation device according to claim 17,
wherein the temperature of the steam generation unit is maintained between the first threshold temperature and the second threshold temperature by reducing an amount of the air supplied to the heating unit when the detected temperature exceeds the second threshold temperature.

23. (canceled)

24. The operation method of a hydrogen generation device according to claim 17,
wherein a change per unit time in the detected temperature is lowered by controlling the any one of supplied amounts and the change per unit time in the detected temperature is maintained between the first threshold value and the second threshold value when the change per unit time in the detected temperature is lower than the second threshold value higher than the first threshold value.

25. The hydrogen generation device according to claim 10, wherein said reforming unit and said steam generation unit are concentrically located in this order toward the periphery around the combustion unit and a combustion gas passage which is a passage of the combustion gas is placed so that a heat is transferred from the reforming unit to the steam generation unit.

26. A fuel cell system having at least the hydrogen generation device according to claim 2 and a fuel cell which generates electric power using a hydrogen-containing gas supplied from the hydrogen generation device and an oxygen-containing gas.
